(19) United States
(12) Patent Application Publication
(10) Pub. No.: US 2010/0198700 A1
(43) Pub. Date: Aug. 5, 2010

(54) System and method for image-based connected mobile shopping aids

(76) Inventor: Satyanarayanan Ramaswamy, Cupertino, CA (US)

Correspondence Address: BRIGHTFON, INC, 7563 HOLLANDERRY PL, CUPERTINO, CA, 95014, US

(21) Appl. No.: 12/658,065

(22) Filed: Feb. 2, 2010

Related U.S. Application Data
(60) Provisional application No. 61/206,815, filed on Feb. 3, 2009.

(51) Int. Cl. G06Q 30/00; G01C 21/00

(52) U.S. Cl. 705/27; 701/201

(57) ABSTRACT

This invention relates in general to mobile phone-based connected shopping aids, and more specifically to a system and method that uses photo images of items needed by the user to construct the user's shopping list stored in the network. The user provides images of the items to be added to her shopping list by taking pictures of such items using a user device or by specifying them from a web site. Such images are uploaded to a shopping list server system in the network where image recognition techniques are used to identify the items. Coupons and promotions relevant to the items in the user's shopping list are also identified by the shopping list server system by analyzing the image items in the shopping list. Such promotions and coupons are presented to the user along with the images of the shopping list item. Routing of the user within the store is performed by analyzing the images in the shopping list, so as to minimize the distance to be traveled by the user within the store.

I HEREBY CLAIM PRIORITY TO MY EARLIER FILED PROVISIONAL PATENT APPLICATION WITH APPLICATION No. 61/206,815 WITH FILING-OR-371(c) DATE: Feb. 3, 2009

### CROSS-REFERENCE TO RELATED APPLICATIONS

Not Applicable

### FIELD OF THE INVENTION

This invention relates in general to mobile phone-based connected shopping aids, and more specifically to a system and method that uses photo images of items needed by the user to construct the user's shopping list stored in the network. Coupons and promotions relevant to the user's shopping list are also identified by the network infrastructure by analyzing the image items in the shopping list. Routing of the user within the store is performed by analyzing the images in the shopping list, so as to minimize the distance to be traveled by the user within the store.

### BACKGROUND OF THE INVENTION

Shoppers typically have a list of items they need to purchase while going to a retail store. Normally, they assemble this list of items mentally over a period of time, or just before embarking on a shopping trip. However, in many cases, the items one might have thought of earlier are forgotten after some time. As a result, multiple trips may have to be made to the retail store, whereas keeping track of the list of needed items reliably could have resulted in only one trip. Even when the shopping list is recorded physically, they are kept track of in pieces of paper or in some electronic form locally in personal storage devices such as in a PDA. However, such a locally stored shopping list is not connected to other relevant and useful pieces of information. For example, significant discounts may be available with coupons for a certain item the user needs. However, in the absence of a network-based mechanism to correlate the need of the user with the coupons that are available (since the user's needs are expressed in disconnected pieces of storage such as paper) the user is unable to take advantage of possible savings. Also, a locally stored shopping list cannot be easily shared with others, for example members of the family. Modern mobile phones come equipped with an inbuilt camera and these phones also have data communication capability. Therefore, it would be very useful if there is an efficient way for the user to record her shopping needs in a network storage using images captured by the camera on her mobile phone as and when a need arises (for example, when she sees a product she likes or when a food item is about to be exhausted in her refrigerator) and then be able to share it with others and access it in a reliable way when going on a shopping trip. Alternatively, when the user is surfing the World Wide Web on a PC, it will be useful if the user can demarcate an area of a web page that has an image of a product the she wants and have that image added to her shopping list. It would also be advantageous for the shopper and advertisers if the image items in the shopping list can be analyzed and linked to related promotions and coupons so that contextual and highly relevant promotions and coupons can be made available to the user.

Prior art solutions to aid the shopper with this problem use a text-based shopping list created by the shopper and conveyed to the in-store system. U.S. Pat. No. 6,912,507 makes use of a text-based shopping list. U.S. Pat. No. 6,123,259 teaches a system in which a shopping list resident on a customer IC card is used in conjunction with a scanner in a mobile terminal to identify an item on a text-based shopping list. U.S. Pat. No. 7,308,356 teaches a system where in-store pico-cell based location information of the shopper is then used in conjunction with a shopping list provided by the shopper to direct the shopper to the next item in a text-based shopping list. Using a pure text based shopping list as in the above prior art limits the potential for its use. There are many instances where the shopper may desire to add an item to a shopping list but simply doesn't desire to perform a text input—for example, when driving or in the midst of a conversation. It may also be cumbersome to convey all the information about a product she wants added to the shopping list using only text. For example, the color, size, and product variation may require a lot of text input to specify exhaustively. True to the saying that one picture is the equivalent of a thousand words, a user may be able to capture an image of a product she desires using the camera on her mobile phone very quickly and easily instead of entering a lengthy description. If the network infrastructure of a system can handle this image as a shopping list item, then a number of useful value-added services can be provided to the user. A key part of the consumer commerce activity is the coupon system where promotions and coupons are issued by retailers and manufacturers and redeemed by consumers at the point-of-sale. It will be very useful if the network infrastructure can automatically identify promotions and coupons that are relevant to the image items in the shopping list and provide it to the user for use in the store and at the point-of-sale.

In this invention, we present a system and method that enables a user to simply use a mobile phone to create a shopping list composed of image items captured using the user's mobile phone camera and stored in the network. The user can then add or delete items at any time, or perform in-store shopping using that shopping list. This invention also enables backend analysis of the user's image based shopping list items so that relevant coupons and promotions can be automatically suggested to the user, where the coupons and promotions are presented right on the mobile phone. Analysis of the image shopping list items is also performed so to order the shopping list items with the objective of minimizing the distance traveled by the user in the store.

### BRIEF SUMMARY OF THE INVENTION

This invention addresses the shortcomings associated with prior art as discussed above, by providing an integrated system and method to store and manage shopping lists in the network using primarily image items and providing an automated way to associate items in the shopping list with available coupons and promotions.

Therefore, consistent with one aspect of the invention a user will be able to set up a shopping list composed of images in the network. Credential information is associated with the shopping list for authentication purposes. When a user wants to add an item to the shopping list, he simply captures an image of the item to be added using his mobile phone's camera and sends it to the network from his mobile. He can also add an image he sees on a web page while visiting that web page from a PC or a web-browsing-capable mobile phone.

Consistent with another aspect of the invention, the image of the shopping list item added by the user is analyzed to extract the text contained in it and that text is used to determine coupons and promotions that could be associated with that shopping list item. The extracted text is also used to determine the most efficient order of shopping within a store by determining the location of items identified by the text and determining the shortest path within the store in order to pick up all items in the shopping list.

Consistent with another aspect of the invention, the image of the shopping list item added by the user is analyzed using image recognition techniques to identify the product wanted by the user and coupons and promotions that could be associated with that shopping list item are determined. This is also used to determine the most efficient order of shopping within a store by determining the location of items identified by the recognized products and determining the shortest path within the store in order to pick up all items in the shopping list.

### BRIEF DESCRIPTION OF THE SEVERAL VIEWS OF THE DRAWINGS

FIG. 1 is an exemplary simplified semi-schematic block diagram of a mobile phone in accordance with this invention.

FIG. 2 is an exemplary simplified block diagram illustrating the communication network that can be used to derive the benefits in accordance with this invention.

FIG. 3 is an exemplary simplified semi-schematic block diagram showing the network elements used to derive the benefits in accordance with this invention.

FIG. 4 is an exemplary simplified semi-schematic block diagram of a network-based Shopping List Server system in accordance with this invention.

FIG. 5 is an exemplary layout of a network-based shopping list with image items and associated information stored in the Shopping List Server system.

FIG. 6 presents an illustration of a web page with an image item that may be added to the shopping list by the user in accordance with this invention.

FIG. 7 presents an exemplary illustration of the types of information extracted from images for adding to the shopping list.

### DETAILED DESCRIPTION OF THE INVENTION

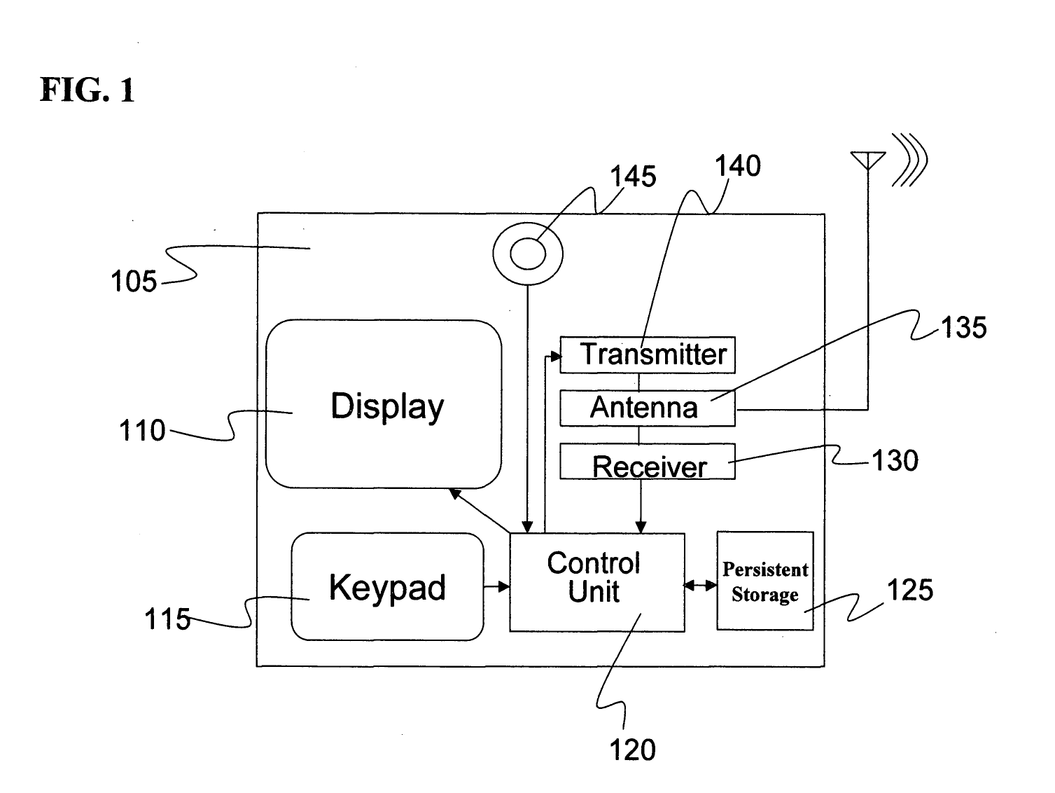

FIG. 1 presents a simplified semi-schematic block diagram of a mobile phone 105 operable in accordance with this invention. The mobile phone 105 consists of a display 110 that is used to display system responses and messages to the shopper. The mobile phone also has a keypad 115 used to obtain shopper-typed inputs to the system. This keypad could be a physical keypad or it could be a soft keypad which is displayed on a touch sensitive display 110 and whose keys are activated by the shopper touching the appropriate displayed key that is desired to be activated. The mobile phone has a control unit 120 that controls all other parts of the mobile phone with either software or hardware commands. The control unit 120 can store data such as images locally in the mobile phone using the persistent storage 125. The control unit is also connected to a receiver 130, antenna 135 and a transmitter 140 that are used collectively to communicate wirelessly with the network. Any one of a variety of technologies can be used to provide the communication link to/from the mobile phone, the only key requirement being that the communication link used by the mobile terminal is wireless. The mobile terminal also has an inbuilt camera 150 using which a shopper can take images. It will be appreciated that the components listed above are typically available in mobile phones. However, it will be evident to one having skill in the art that a mobile terminal with the above components can also be created specifically for providing the benefits and purposes of this invention.

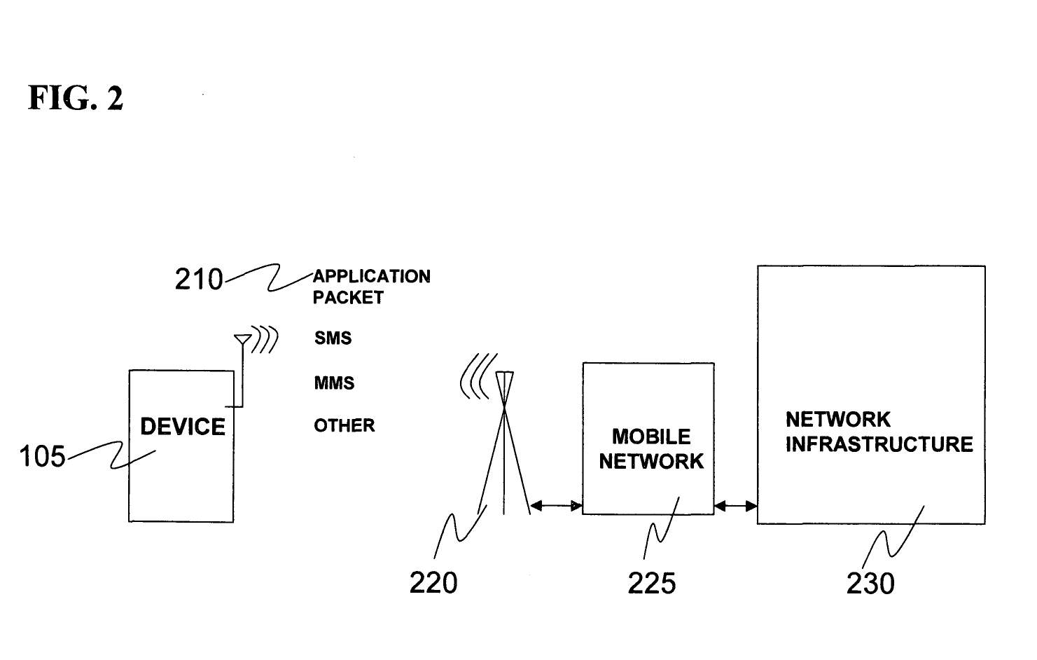

FIG. 2 illustrates the link that connects the mobile phone 105 with the network infrastructure 230. In one preferred embodiment of this invention, the mobile phone is connected to the network infrastructure 230 via a wireless communication system 220 such as CDMA, GSM, UMTS, Wi-Fi, Wi-Max, etc. The mobile phone 105 and the network infrastructure 230 can communicate commands and responses with each other using one of many possible transport mechanisms 210. This could include application data packets such as those on networks based on the Internet Protocol standards, Short Message Service (SMS) or Multimedia Messaging Service (MMS), or any other suitable communication technique that can carry image files and is understood by the mobile phone 105 and the network infrastructure 230.

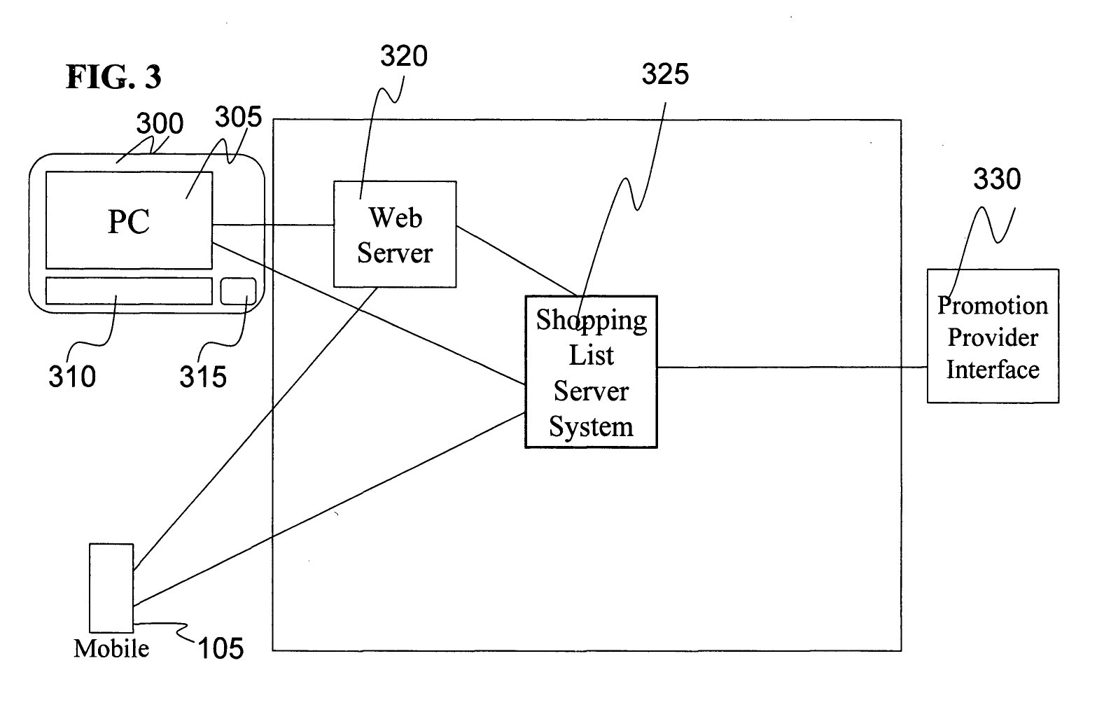

FIG. 3 presents a simplified semi-schematic block diagram showing the network infrastructure elements of the system in accordance with the principles of this invention. The user may access a web page from a traditional PC 300 that has a display monitor 305, a keyboard 310 and optionally a mouse 315 or from a mobile phone 105. The web page is served to the user from a web server 320. In one embodiment of this invention, the web server interacts with the Shopping List Server system 325 to add an image on the web page to the user's shopping list. Alternatively, in another embodiment of the principles of this invention the PC client software in accordance with this invention interacts with the Shopping List Server system 325 to add an image on the web page to the user's shopping list. Providers of coupons and promotions can use a promotion provider interface 330 to input coupons and promotions to the Shopping List Server system 325 for associating with users' shopping list items in accordance with this invention.

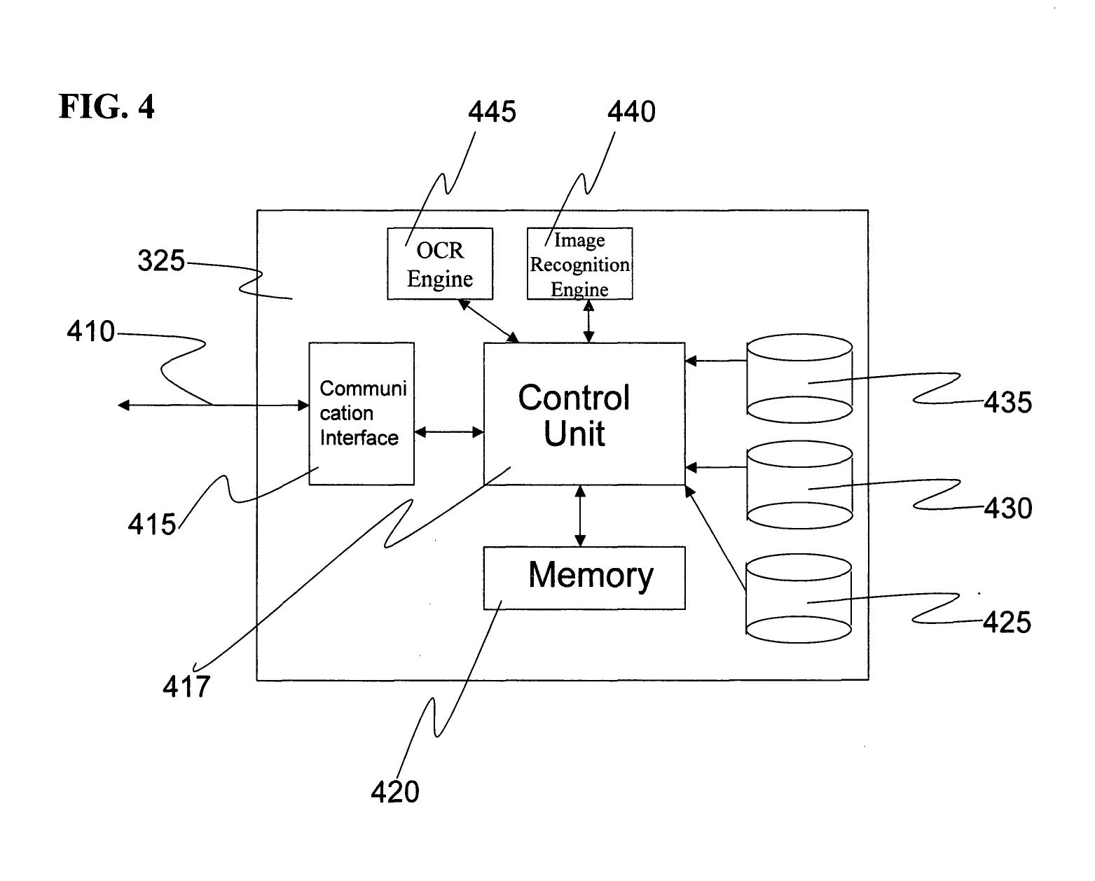

FIG. 4 presents a simplified semi-schematic block diagram of a Shopping List Server system 325 operable in accordance with this invention. This system consists of a communication link 410 that is used to connect with a plurality of mobile phones 105, for providing this service, plurality of PCs 300, as well as connect with the other elements of the network infrastructure. The Shopping List Server system is controlled by a control unit 417 that performs the shopping list server logic of the system as embodied in this invention. The control unit 417 is connected to the communication link via a communication interface 415. The control unit is connected to memory 420 to store and performs operations on the databases as presented in this invention. The Shopping List Server system consists of a shopping list database 425 that is used to store the shopping lists 500 corresponding to a plurality of individual shoppers. The Shopping List Server system consists of a promotions database 430 that is used to store promotions and coupons, along with associated metadata information such as associated keywords and related products. In addition, a storemap database 435 is also present in the Shopping List Server system—this database contains the layout of stores and for all items sold in each store, the location in that store where the given item is stocked. The control unit 417 is connected to an image recognition engine 440 that when provided with an image can recognize the products in the image and provide the results in text form. The control unit is also connected to an Optical Character Recognition (OCR) Engine 445 that can recognize the text in a given image. It will be evident to one with skill in the art that the schematic in FIG. 4 is intended to be indicative of the functionality required and is not prescriptive of any specific hardware or software architecture. The components of this functional schematic can be distributed across multiple distributed physical servers and modularized along specific roles required to be performed by the control unit 417.

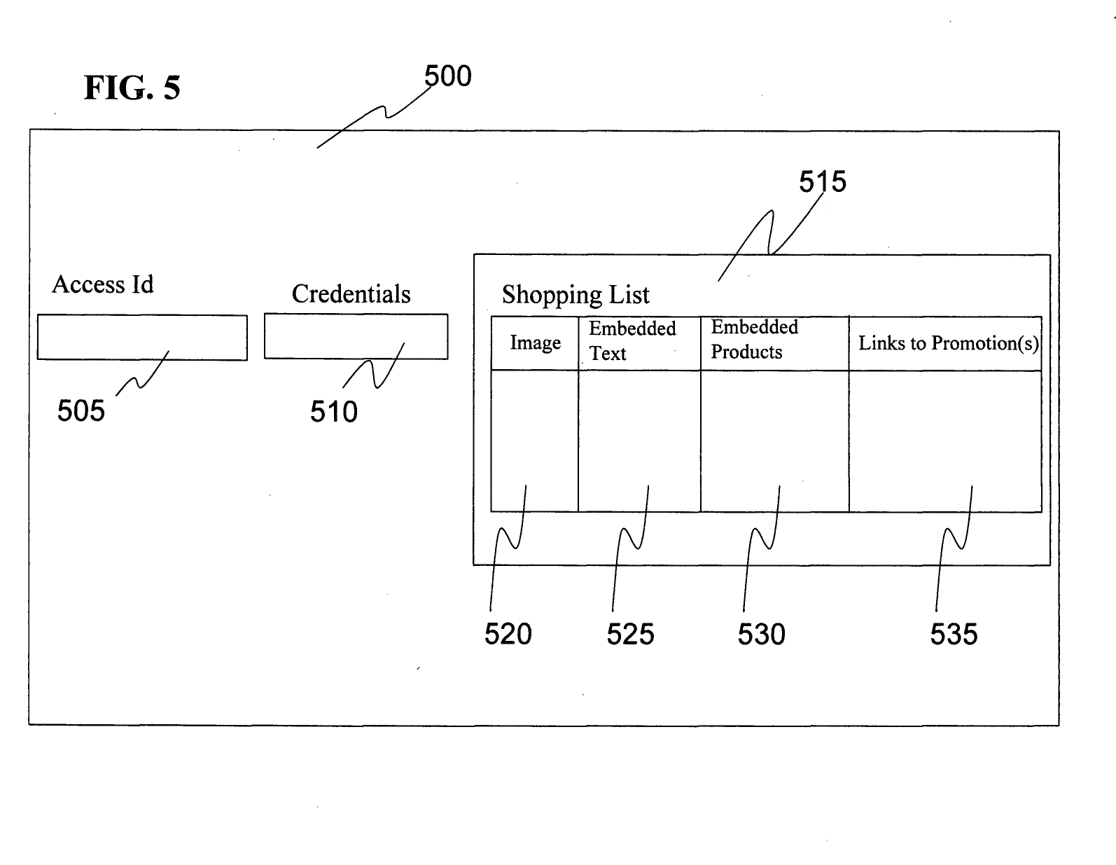

FIG. 5 illustrates a general schematic of the shopping list and associated information 500 for a given user in accordance with this invention. The Shopping List Server system 325 can support a plurality of users and hence each user will have a separate shopping list and associated information. Each shopping list has an Access Id 505 that is used to uniquely identify a user account and associated credential information 510 such as password or a PIN. The shopping list 515 consists primarily of the images 520 used as shopping list items, the text found embedded in the image 525, products found embedded in the image 530, and links to related promotions 535.

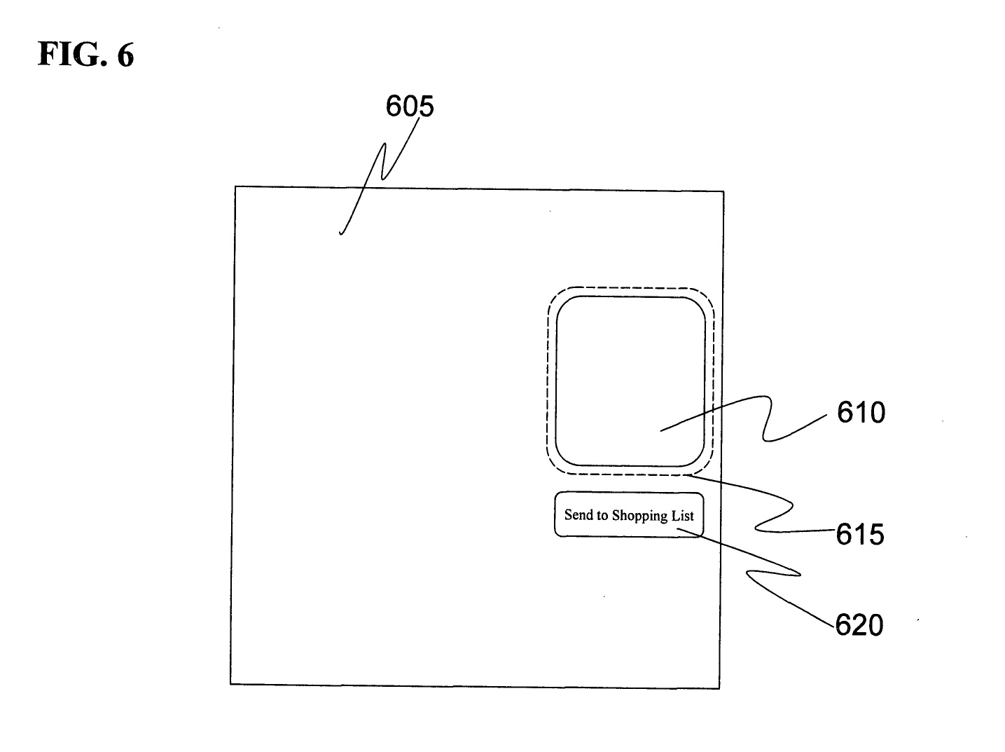

FIG. 6 presents an illustration of the user experience while adding an image seen on a web page to the shopping list. A user visits a web page 605 while surfing the World Wide Web. This web page may typically be a web site she is visiting while surfing the web from a PC. However, the web site may be visited from a web-enabled mobile device such as an iPhone as well. On the web page 605, the user sees an image of a product 610 being presented and desires to add it to his shopping list. The web page may provide an explicit control 620 for sending the image to his shopping list. This control could be a “button” control or a “link” control or some such mechanism which can be activated when the user selects it, for example by clicking on it. Alternatively, the user may be able to select the image itself (for example, by right clicking on the image) to send it to her shopping list. Upon the user selecting the image, it may be highlighted 615. When the user activates the control 620 or selects the image as above, a dialog appears which requests the user to provide his Access Id and Credential Information. Upon receiving these and validating them, the image is added to the user's shopping list 515. More detailed description of the operation in accordance with the principles of this invention is presented in the following discussion.

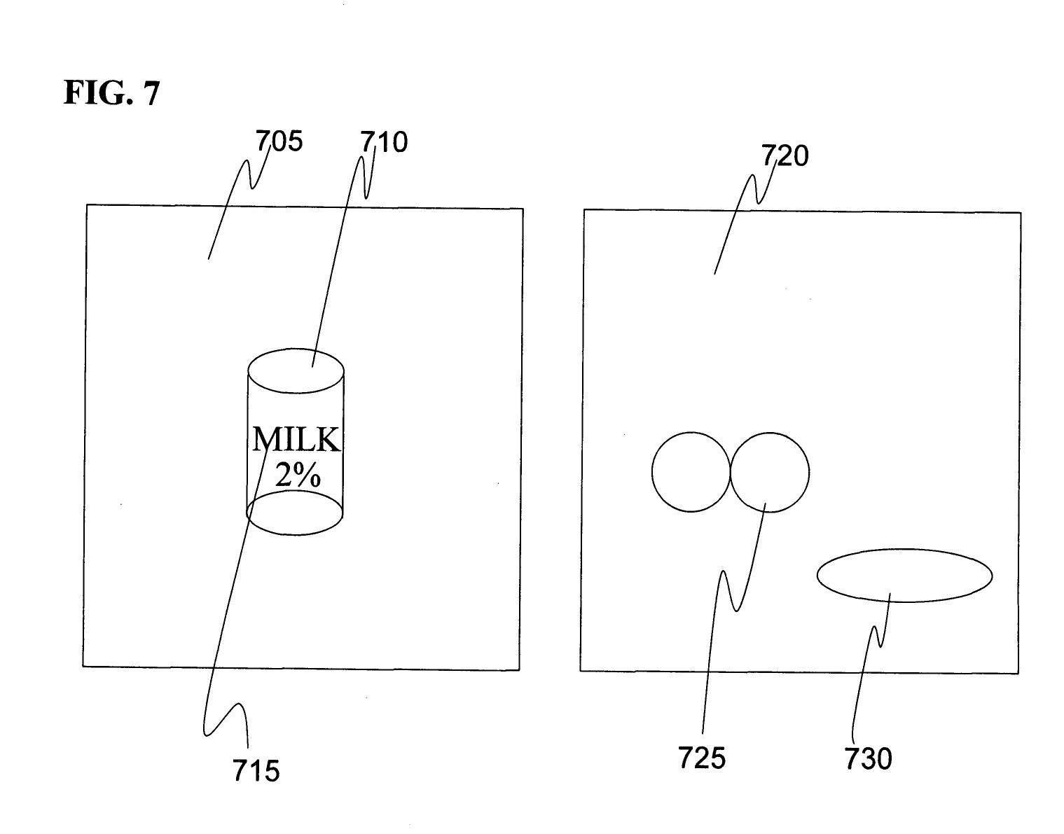

FIG. 7 presents an exemplary illustration of the types of information that are extracted from images added by the user to her shopping list. Image 705 shows examples of text extracted from an image shopping list item using the OCR Engine 445. In this example, the image has a container that shows the text “Milk” and “2%” on it. The OCR Engine 445 will extract these two pieces of text for use as text tags of the shopping list item and in identifying relevant promotions. Image 720 shows an example where no text is available in the image. The image recognition engine 440 may identify the objects 725 as oranges and 730 as cucumber, in which case “oranges” and “cucumber” are added as text tags for the shopping list item and also for determining relevant promotions.

Operation of a particular embodiment in accordance with the practice of principles of this invention will be described below. As a first step, the user is required to create an account by providing an Access Id and a corresponding credential information, for example, a six digit PIN (personal identification number). Upon creating an account an empty shopping list is created and stored in accordance with FIG. 5 in the shopping list database 425 in the shopping list server system 330. Alternatively, a persistent random identifier (such as a cookie used in web communication) could be used to identify individual users.

Once the user has created an account, she can now access the image based shopping list management system as below. When the user wants to add an image item to her shopping list from her mobile phone 105, she connects to the shopping list server system 325 from the mobile phone. Upon validating the user's Access Id 505 and credential information 510, the shopping list server identifies the corresponding shopping list 515. The user is then asked to capture an image of the item she wants to add to the shopping list using the mobile phone's camera 145. The image captured by the user is stored locally in the persistent storage 125 in the mobile with a unique id. The image is also sent to the shopping list server system 325 by the mobile phone 105. The image sent by the user is stored by the shopping list server system 325 as an entry 520 in the shopping list 515. Then the shopping list server system 325 uses the OCR Engine 445 to extract all the text in the image. For example, if a text in the image says “2% milk”, then “2% milk” in text is stored in the table 515 as embedded text 525. The extracted text is also corrected for any possible errors so that the resulting text is a valid text. The extracted text can also be compared with the past shopping history of the user to identify previous instances where the extracted text was similar and the corresponding item the user may have bought using that shopping list. This is done to make the embedded text extracted using OCR Engine 445 even more accurate. In many instances, there may not be any text present in an image. For example, when the user has taken the picture of a vegetable, no text will be available. The shopping list server system 325 uses the Image Recognition Engine 440 to identify products in the image and obtains the result of the recognition as text. For example, if the Image Recognition Engine recognizes a mango in the image, it returns “mango”. This text is stored in the embedded products field 530 corresponding to the image's shopping list item. The extracted embedded text and embedded products information is then matched with existing coupons and promotions in the database 430 to identify relevant coupons and promotions. For example, coupons and promotions that are linked to keyword “mango” or “mangoes” is linked to this shopping list item. When new promotions or coupons are added to the system, existing shopping list items that have correlating keywords in embedded text 525 or embedded products 530 are also linked to them in 535.

In another preferred embodiment of this invention, when the user wants to add an image on a web page 605 to her shopping list, she activates the control 620 or selects the image 610 depending on the specific interface supported as discussed before. When the user does the above, she is asked for her Access Id 505 and credential information 510. Upon validating the user's Access Id 505 and credential information 510, the shopping list server identifies the corresponding shopping list 515. The PC 300 then uploads the selected image to the shopping list server system 325. Alternatively, the web server 320 may upload the image to the shopping list server system 325. Additional information such as a text description of the product and associated keywords may also be sent. This image is stored by the shopping list server system 325 as an entry 520 in the shopping list 515. Then the shopping list server system 325 uses the OCR Engine 445 to derive all the text in the image. For example, if a text in the image says “2% milk”, then “2% milk” in text is stored in the table 515 as embedded text 525. The additional information sent along with the image may also be stored in embedded text field 525. The extracted text is also corrected for any possible errors so that the resulting text is a valid text. The extracted text can also be compared with the past shopping history of the user to identify previous instances where the extracted text was similar and the corresponding item the user may have bought using that shopping list. This is done to make the embedded text extracted using OCR Engine 445 even more accurate. The shopping list server system 325 then uses the Image Recognition Engine 440 to identify products in the image and obtains the result of the recognition as text. For example, if the Image Recognition Engine recognizes a mango in the image, it returns “mango”. This text s stored in the embedded products field 530. The extracted embedded text and embedded products information is then matched with existing coupons and promotions in the database 430 to identify relevant coupons and promotions. For example, coupons and promotions that are linked to keyword “mango” or “mangoes” is linked to this shopping list item. When new promotions or coupons are added to the system, existing shopping list items that have correlating keywords in embedded text 525 or embedded products 530 are also linked to them.

When the user or someone she designates is in the retail store and is ready to start shopping, she accesses the Shopping List Server system 325 from mobile phone 105. Once the authentication step is performed to verify the Access Id and credential information, the user selects a “Start Shopping” option. To help the user finish shopping with the least effort in a given store, the user is asked to identify the store where she is present. This could be done, for example, by the user specifying a store number. Alternatively, an optional GPS receiver on the mobile phone 105 can be used to detect the geo location of the mobile and thereby the store where the user is located is identified. As another alternate mechanism, the IP address of the mobile phone may be used to identify the store where the user is located, if the user is accessing the shopping list server system from an in-store Wi-Fi network. Once the store where the user is located is determined, the embedded text 525 and embedded products 530 corresponding to the items in the user's shopping list are used to identify the locations in the store where the specific items are located. For example, if the embedded products field 530 for an item is “mango”, then the location of mangoes in the store is identified as the location corresponding to that shopping list item. Once the location of all items are identified, the Shopping List Server system reorders the shopping list so that if the user goes from one item to the next as in the new order, shopping can be performed in the least distance. The Shopping List Server system 325 then provides instruction to the user on mobile phone 105 directing the user to the first item in the shopping list whose image 520 stored in the shopping list 515 is also provided. For example, it could say “Go to Aisle 2 front section to pick up Item 1” along with the shopping list item image 520. The user is also informed about coupons and promotions linked to that item. The user is then asked if she wants to redeem the presented coupon(s). When the user is ready to go to the next item, the shortest path from the current location to the location of the next item on the list is computed by the shopping list server system 325 and presented to the user on the mobile phone 105. For example, it could say “go to the back of this aisle, take a right turn and go to aisle 6”. This process is repeated till there are no more items in the shopping list.

At the checkout counter, when the user's items are being checked out by the sales clerk or using a self-checkout counter, the shopping list server sends to the mobile phone the coupon details such as a Coupon Id for each coupon the user has added. The necessary coupon details are entered by the sales clerk into the point-of-sale terminal in order to apply the coupon's discount to the user's purchase.

In another preferred embodiment of this invention, image based shopping list items as discussed above can be mixed with text-based shopping list items to create a hybrid shopping list that contains both text and image-based items. Each type of item is identified distinct from the other, so that the user can see the image based shopping list items and read the text-based shopping list items when accessing her shopping list.

In another preferred embodiment of this invention, the copy of the image stored in the mobile phone's persistent storage 125 is used when displaying the shopping list item to the user on the mobile phone 105, so that transferring the image from the shopping list server 325 to the mobile phone 105 for presentation is avoided, thereby saving bandwidth and time.

In another preferred embodiment of this invention, an image stored locally on the mobile phone 105, any storage devices attached to the mobile phone 105, or an image stored in a storage device attached to the PC 300, can be uploaded by the user to the Shopping List Server system 325 for use as a shopping list item in accordance with this invention.

What is claimed is:

1. A system and method for image-based connected shopping aids, the system comprising of a user device capable of providing images of products the user wants to add to her shopping list, a network-based shopping list server system where such images can be stored and analyzed, a communication network connecting the two, and an interface for providers of promotions and coupons to communicate them to the shopping list server system; the method comprising the steps of the user providing an image of the product she wants to add to the shopping list, automatically or manually uploading the image to the shopping list server system, analyzing the image at the shopping list server system by using image recognition techniques to identify the product or its type, associating promotions and coupons related to the product so identified, and presenting such related promotions and coupons to the user along with the image of the shopping list item.

2. The system and method of claim 1, wherein the shopping list is sorted to minimize the distance to be traversed within the store to pick up the items and the user is provided directions within the retail store from one product to the next on the shopping list based on the location of such items in the store.

3. The system and method of claim 1, wherein shopping list items in text are used in addition to images of items.

4. The system and method of claim 1, wherein images of the shopping list items are stored locally within the user device for display to the user in addition to being sent to the shopping list server system.

5. The system and method of claim 1, wherein the image of the shopping list item is taken using a camera on the user device.

6. The system and method of claim 1, wherein the user device is a personal computer and the image is obtained from a web site the user is viewing.

7. The system and method of claim 1, wherein the product image is obtained from a storage device attached to the user device.
